(19) United States
(12) Patent Application Publication
(10) Pub. No.: US 2016/0214030 A1
(43) Pub. Date: Jul. 28, 2016

(54) ADSORBENT AND ADSORPTION APPARATUS USING THE SAME

(71) Applicant: Kabushiki Kaisha Toshiba, Minato-ku (JP)

(72) Inventors: Katsuyuki Naito, Tokyo (JP); Akiko Suzuki, Tokyo (JP); Toshihiro Imada, Kanagawa-ken (JP)

(73) Assignee: Kabushiki Kaisha Toshiba, Minato-ku (JP)

(21) Appl. No.: 15/002,778

(22) Filed: Jan. 21, 2016

(30) Foreign Application Priority Data
Jan. 21, 2015 (JP) 2015-009756

(51) Int. Cl. B01D 15/08; C02F 1/48; C02F 1/28; B01J 20/02; B01J 20/28

(52) U.S. Cl. CPC B01D 15/08; B01J 20/02; B01J 20/28009; B01J 20/28002; C02F 1/283; C02F 1/48; C02F 2101/322

(57) ABSTRACT

An adsorbent containing graphene oxide having a shoulder peak at a wavelength of about 300 nm, wherein an absorbance at 600 nm is not less than 15% and not more than 60% of an absorbance at 300 nm, and an adsorption apparatus having an adsorption tank containing the adsorbent can be obtained.

### CROSS-REFERENCE TO RELATED APPLICATION

This application is based upon and claims the benefit of priority from the prior Japanese Patent Application No. 2015-009756, filed on Jan. 21, 2015, the entire contents of which are incorporated herein by reference.

### FIELD

Embodiments of the present invention relate to an adsorbent consisting of graphene oxide which adsorbs harmful substances or useful substances and an adsorption apparatus using the same.

### BACKGROUND

Various substances are contained in wastewater. Recently, environmental hormone such as phenols has become a problem. In addition to this, conventional heavy metal ions, and recently radioactive metals and so on have become a problem. An adsorbent and an adsorption apparatus for removing these efficiently and in large amounts have been required. In addition, it is required to effectively adsorb and easily collect useful substances such as rear earths. Further, it is necessary that they are inexpensive, because objects to be treated are large amounts.

Graphene oxide is extremely inexpensive material which is obtained from graphite and so on as raw materials by oxidation reaction. It is known that graphene oxide has a carboxyl group and a hydroxyl group and so on, and adsorbs multivalent metal and so on (Patent Document 1). But, in the present circumstances, the adsorption selectivity of graphene oxide with respect to phenol has not been known. This was because graphene oxide is not one compound, but has various molecular structures.

### BRIEF DESCRIPTION OF THE DRAWINGS

FIG. 1 is a schematic diagram of an apparatus using an adsorbent consisting of graphene oxide of an embodiment.

FIG. 2 is an absorption spectrum of the graphene oxide in an example 1.

FIG. 3 is an absorption spectrum of the graphene oxide in a comparative example 2.

### DETAILED DESCRIPTION

An embodiment makes it an object to obtain a adsorbent consisting of new graphene oxide which exhibits adsorption property to polar organic compounds (phenols and so on) having an aromatic ring, and adsorption property to metal ions or amine and so on, and is easily dispersed in water and aggregated, and precipitated/filtered and separated, and an adsorption apparatus using the same.

An adsorbent of an embodiment has a shoulder peak at a wavelength of about 300 nm of graphene oxide, and an absorbance at 600 nm is not less than 15% and not more than 60% of an absorbance at 300 nm.

In addition, an adsorption apparatus of an embodiment is an adsorption apparatus comprising an adsorption tank having adsorbent containing graphene oxide, means for supplying water containing substance to be adsorbed which can be adsorbed by the adsorbent, and means for discharging water in which at least a part of the substance to be adsorbed has been adsorbed by the adsorbent, wherein the adsorbent has a shoulder peak at a wavelength of about 300 nm of the graphene oxide, and an absorbance at 600 nm is not less than 15% and not more than 60% of an absorbance at 300 nm.

### Embodiment

A graphene oxide adsorbent of an embodiment is characterized in that it has a shoulder peak at a wavelength of about 300 nm of graphene oxide, and an absorbance at 600 nm is not less than 15% and not more than 60% of an absorbance at 300 nm.

### <Adsorbent>

The shoulder peak at a wavelength of about 300 nm of graphene oxide corresponds to n-π* transition of a carbonyl group. The absorption at 600 nm corresponds to a π electronic system, and corresponds to a nanographene portion. Here, the shoulder peak is an inflexion point, or shows adsorption maximum. That the absorbance at 600 nm is not less than 15% of the absorbance at 300 nm shows that the nanographene portions are rather many. On the other hand, that the shoulder peak exists at about 300 nm shows that many hydrophilic carboxyl groups exist. For the reason, the adsorption property thereof to polar organic compound (phenols and so on) having an aromatic ring, and adsorption property thereof to metal ions and amine and so on can be exhibited. On the other hand, when the absorbance at 600 nm is larger than 60% of the absorbance at 300 nm, the dispersibility thereof to water becomes worse, and the adsorption performance thereof deteriorates. Accordingly, more preferably, the absorbance at 600 nm is not less than 20% and not more than 50% of the absorbance at 300 nm.

An absorbance thereof can be measured in any of a state to be dispersed in water, or a state to be placed on a substrate of quartz or the like. When scattered light exists such as on a carrier, it is preferable to measure an absorption spectrum using an integrating sphere. When absorption exists at 300 nm and 600 nm in the carrier, it is preferable to measure an absorbance with reference to a carrier without carrying. When a carrier is an inorganic oxide, a carrier in which graphene oxide has been combusted and removed may be referred to.

Graphene oxide may be of a single layer or a multilayer. In addition, regarding a size of graphene oxide, the shortest diameter of a graphene oxide sheet is preferably not less than 0.1 μm and not more than 100 μm. When the diameter is smaller than 0.1 μm, the aggregability thereof becomes small, and the precipitation and filtration thereof become difficult. In addition, the diameter is larger than 100 μm, since active edges become small, the adsorption performance thereof deteriorates. Preferably, the diameter is not less than 0.5 μm and not more than 10 μm.

A size of graphene oxide can be directly measured using a scanning electron microscope or an atomic force microscope. In this case, since the measurement thereof is difficult in an aggregation state, the size is preferably measured by applying graphene oxide on a substrate, using a dilute solution thereof or adjusting pH thereof to eliminate an aggregation state. When a carrier is not used, a particle size thereof can be measured using laser scattering.

It is preferable that graphene oxide is characterized in that nitrogen atoms are contained not less than 0.1% and not more than 30% of carbon atoms therein. When nitrogen atoms exist, adsorption ability to metal ions and phenol increases. If the ratio is smaller than 0.1%, there is no effect at all, and if the ratio is larger than 30%, since the amount of oxygen decreases, and thereby the adsorption ability is also decreased. Preferably, the ratio is not less than 1% and not more than 10%.

It is preferable that a ratio of oxygen atoms to carbon atoms in graphene oxide is not less than 10% and not more than 50%. If the ratio is smaller than 10%, the hydrophilic property decreases, and thereby the dispersibility and ion adsorption ability decrease. If the ratio is larger than 50%, the number of nanographene portions becomes small, and the adsorption performance of phenol decreases. Preferably, the ratio is not less than 20% and not more than 40%. An amount of nitrogen and an amount of oxygen can be obtained by performing chemical elementary analysis. Or, they can be obtained by an X-ray photoelectron spectroscopy (XPS).

It is preferable that graphene oxide is carried by a carrier. As a carrier of graphene oxide, metal oxide, cellulose, polyvinyl alcohol and so on can be listed. Each of these carriers has many hydroxyl groups at the surface, and has a sufficient strength as a carrier of graphene oxide. The hydroxyl group on the surface of the carrier becomes a functional group for combining with the graphene oxide.

As a metal oxide carrier, silica (SiO2), titania (TiO2), alumina (Al2O3), and zirconia (ZrO2), zircon (ZrSiO4), ferrous oxide (FeO), ferric oxide (Fe2O3) triiron tetroxide (Fe3O4), cobalt trioxide (CoO3), cobalt oxide (CoO), tungsten oxide (WO3), molybdenum oxide (MoO3), indium tin oxide (In2O3-SnO2: ITO), indium oxide (In2O3), lead oxide (PbO2), niobium oxide (Nb2O5), thorium oxide (ThO2), tantalum oxide (Ta2O5), rhenium trioxide (ReO3), chrome oxide (Cr2O3), and in addition, salt of oxy metal acid, such as zeolite (aluminosilicate), lead zirconate titanate (Pb(ZrTi)O3: PZT), calcium titanate (CaTiO3), lanthanum covaltate (LaCoO3), lanthanum chromate (LaCrO3), barium titanate (BaTiO3), and alkoxide, halide and so on for forming them can be listed.

In the above-described carriers, titania, alumina, zirconia, zircon are inexpensive, and a surface potential (zeta potential) of each of them is about 0 mV or positive in a neutral state (pH 7), and each of them can stably carry graphene oxide having a negative surface potential. Here, about 0 mV means approximate 0 V, and is within the range of ±5 mV around 0 mV in consideration of measurement error. In addition, iron oxide and cobalt oxide have magnetism, and are preferable, because separation using a magnet is enabled.

In the case of a column to which adsorbent is fixed, regarding a size of a carrier, an average primary particle size is preferably not less than 100 μm and not more than 5 mm. When an average primary particle size of a carrier is set to not less than 100 μm and not more than 5 mm, a magnitude of a filling rate into adsorbent and easiness of water passing can be made compatible with each other. When the average primary particle size is less than 100 μm, a filling rate of the adsorbent into a column or the like becomes too high, and a rate of void is decreased, and thereby it becomes difficult to pass water. On the other hand, when the average primary particle size exceeds 5 mm, a filling rate of the adsorbent into a column or the like becomes too low, and voids are increased, and thereby it becomes easy to pass water, but a contact area between the adsorbent and water containing substance to be adsorbed decreases, and thereby the adsorption rate by the adsorbent is decreased. A preferable average primary particle size of a carrier is not less than 100 μm and not more than 2 mm, and more preferably, it is not less than 300 μm and not more than 1 mm.

The average particle size can be measured with a sifting method. Specifically, the average particle size can be measured by sifting particles using a plurality of sifters with mesh openings from 100 μm to 5 mm, in accordance with JIS Z8901: 2006 “testing powder and testing particle”.

On the other hand, in the case of an adsorption tank or a fluidized bed of a batch type, since the adsorbent itself is fluidized, it is preferable that the primary particle size of a particle of the carrier is not less than 1 μm and not more than 1 mm, and the carriers are filtered by a filter or are prevented from flowing out. In the case of the magnetic particle, since it can be aggregated by magnet, the primary particle size is preferably not less than 100 nm and not more than 1 mm.

### <Method of Manufacturing Adsorbent>

Graphene oxide can be manufactured by a following method, for example. Inside of mixed liquid of concentrated sulfuric acid and sodium nitrate is cooled, and graphite powder is gradually added thereto at about 5° C. Next, powder of potassium permanganate is gradually added thereto while being cooled. The temperature of the reaction solution rises to about 10° C. Next, after the solution is stirred for about 4 hours at room temperature, water is gradually added thereto, and the solution is subjected to reflux heating for 30 minutes. After cooling the solution to room temperature, hydrogen peroxide water is dropped therein. The obtained reaction mixture is centrifuged to collect the precipitate. The precipitate is washed with dilute hydrochloric acid for several times, and after being centrifuged, it is subjected to depression heating drying at 80° C., to obtain graphene oxide.

It is possible to control the size, the number of layers, the oxidation degree, and so on of the obtained graphene oxide, depending on graphite that is raw material and the reaction condition.

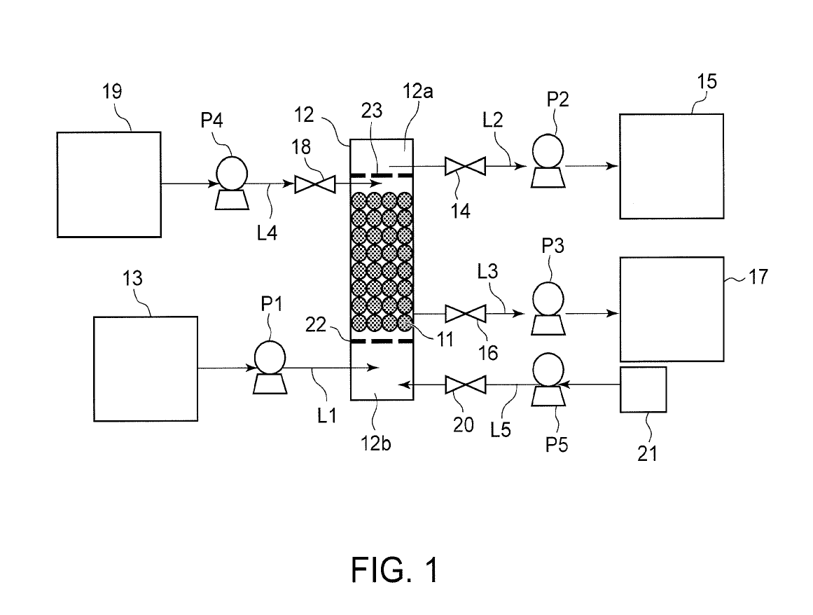

An example of an adsorption apparatus having adsorbent containing graphene oxide of an embodiment is shown in FIG. 1. An adsorption apparatus 10 is characterized by having an adsorption tank 12 containing adsorbent 11 which has an absorption maximum or a shoulder peak at a wavelength of about 300 nm of graphene oxide, and in which an absorbance at 600 nm is not less than 15% and not more than 60% of a maximum absorbance at about 300 nm. This manufacturing method of graphene oxide is not limited to the above-described method, but graphene oxide can also be manufactured by a method using ozone, a method of using combination of ozone and ultraviolet irradiation, a method using oxygen plasma, and so on, for example.

### <Adsorption Apparatus>

The adsorption apparatus 10 of the present embodiment is provided with the adsorption tank 12 to which a supply line L1 of water containing substance to be adsorbed, a discharge line L2 of treated water, an adsorbent discharge line L3, an adsorbent supply line L4, and a pH adjusting liquid supply line L5 are connected, and in which a fluidized bed of the adsorbent 11 is formed.

The supply line L1, having a pump P1, of water containing substance to be adsorbed is connected to a lower portion 12b of the adsorption tank, and the water containing the substance to be adsorbed is configured to be introduced into the adsorption tank 12 from a supply source 13. In addition, the treated water discharge line L2 having a pump P2 and an on-off valve 14 is connected to an upper portion 12a of the adsorption tank, and the treated water is configured to be discharged to a treated water discharge portion 15 from the adsorption tank 12. In addition, the line L3 having a pump P3 and an on-off valve 16 is connected to an adsorbent layer in the vicinity of the lower portion 12b of the adsorption tank, and the adsorbent 11 is configured to be discharged from the adsorption tank 12 to an adsorbent discharge portion 17. The adsorbent supply line L4 having a pump P4 and an on-off valve 18 is connected to the vicinity of the upper portion 12a of the adsorption tank, and the adsorbent 11 is configured to be supplied from an adsorbent supply source 19. The pH adjusting liquid supply line L5 having a pump P5 and an on-off valve 20 is connected to the vicinity of the lower portion 12b of the adsorption tank, and the pH adjusting liquid is configured to be supplied from a pH adjusting liquid supply source 21.

Here, the pH adjusting liquid supply source 21 as pH adjusting means is connected to the adsorption tank 12, and is pH adjusting means for controlling pH in the adsorption tank 12. Filters 22 and 23 are porous bodies so that the adsorbent 11 does not flow out therefrom. Further, the distance from the fluidized bed of the adsorbent 11 to a communication opening of the treated water discharge line L2 is set so that the substance to be adsorbed is sufficiently absorbed by the adsorbent.

FIG. 1 shows the fluidized bed, but a precipitation tank or a usual fixed tank of a column may be used. In the case of continuously treating a large amount, a fluidized bed is preferable, and a precipitation tank is preferable, as a batch system with a simple structure, and a fixed tank is preferable for continuous treatment of a small amount.

As described above, it is preferable that the adsorption apparatus is characterized by having means for controlling pH. pH is controlled, and thereby the selectivity with respect to the substance to be adsorbed can be controlled, and in addition, it is possible to simply perform collection of the absorbed substance, and recycle of the adsorbent.

### Example 1

Graphene oxide is synthesized using, as graphite, Z-5F made of ITO GRAPHITE as raw material. Z-5F 50 g, concentrated sulfuric acid 1000 ml, sodium nitrate 22 g are mixed, and are cooled to 4° C. or lower. Potassium permanganate 120 g is gradually added thereto, while being cooled. The solution is stirred for one hour at 6° C. or lower, and for 4 hours at room temperature. Then, after being heated and refluxed for 20 minutes, the solution is cooled to a room temperature. After hydrogen peroxide water is added thereto, the obtained reaction mixture is filtered, and is sufficiently washed with dilute hydrochloric acid. After being cooled with air current, the mixture is dried under reduced pressure at 60° C., and thereby graphene oxide 70 g is obtained.

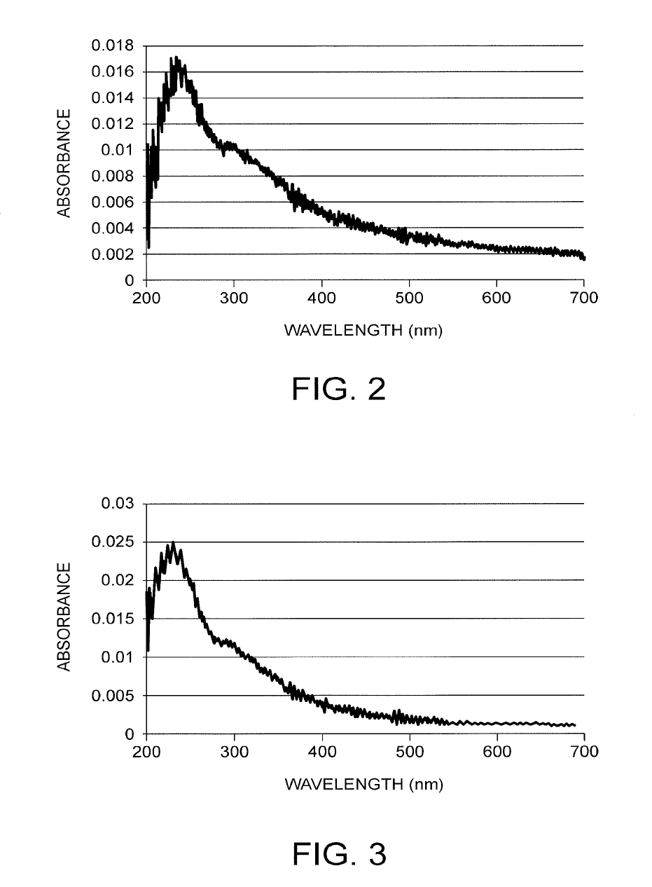

An absorption spectrum of a sample obtained by spin coating aqueous dispersion of the obtained graphene oxide on a quartz substrate is shown in FIG. 2. A shoulder peak is exhibited at a wavelength of about 300 nm of graphene oxide, and an absorbance at 600 nm is 25% of a absorbance at 300 nm. Here, about 300 nm of the wavelength is called a range of 30 nm before and after around 300 nm. In addition, the shoulder peak means that inflection point or absorption maximum is exhibited at about 300 nm.

From the analysis of this graphene oxide by XPS, a ratio of oxygen atoms to carbon atoms is 37%, but it is because of the above-described reason that the similar property is exhibited, if a ratio of oxygen atoms to carbon atoms is not less than 10% and not more than 50%. In addition, a ratio of nitrogen atoms to carbon atoms is 1%, but it is because of the above-described reason that the similar property is exhibited, if a ratio of nitrogen atoms to carbon atoms is not less than 0.1% and not more than 30%. Graphene oxide 30 mg is added to water to be treated 3 mL containing phenol by 20 mg/L, and the water to be treated is stirred for 1 hour at room temperature. The water to be treated is filtered by an MCE membrane filter of 0.22 μm, and is extracted with chloroform. A concentration of phenol in chloroform after the extraction is quantitated by GC/MS. An adsorption amount of phenol is 62%.

### Example 2

Aqueous solution containing 0.1 mM of dysprosium is prepared using 0.2 M of ammonium acetate buffer solution. Further, waters to be treated of 4 kinds of pH 4, 5, 6, 7 are manufactured, using sodium hydroxide of 1 normal or hydrochloric acid of 1 normal, as a pH adjuster. The graphene oxide 20 mg to be obtained in the example 1 is added to each of the waters to be treated 50 mL, and the each water is stirred for six hours at room temperature. After having been stirred, the water to be treated is filtered by an MCE membrane filter of 0.22 μm, and metal concentration of the filtrate is measured. A metal adsorption amount is calculated from the difference between the metal concentrations before and after adsorption. Masses mg of dysprosium per graphene oxide 1 g are 11 mg at pH 4, 11 mg at pH 5, 12 mg at pH 6, 20 mg at pH 7, the absorbing power in a neutral region is high, and pH is made lower and thereby dysprosium can be collected.

### Example 3

In the same manner as the example 1 except that graphene oxide which has a shoulder peak at a wavelength of about 300 nm, and in which an absorbance at 600 nm is 50% of the absorbance at 300 nm, a ratio of oxygen atoms to carbon atoms is 22% from the analysis by XPS is used, in place of the graphene oxide used in the example 1, an adsorption amount of phenol is measured. The adsorption amount of phenol is 55%.

### Example 4

In the same manner as the example 1 except that graphene oxide which has a shoulder peak at a wavelength of about 300 nm, and in which an absorbance at 600 nm is 15% of an absorbance at 300 nm, and a ratio of oxygen atoms to carbon atoms is 48% from the analysis by XPS is used, in place of the graphene oxide to be used in the example 1, an adsorption amount of phenol is measured. The adsorption amount of phenol is 45%.

### Example 5

In the same manner as the example 1 except that graphene oxide which has a shoulder peak at a wavelength of about 300 nm, and in which an absorbance at 600 nm is 60% of an absorbance at 300 nm, and a ratio of oxygen atoms to carbon atoms is 12% from the analysis by XPS is used, in place of the graphene oxide to be used in the example 1, an adsorption amount of phenol is measured. The adsorption amount of phenol is 50%.

### Example 6

The graphene oxide to be obtained in the example 1 and zirconia beads with a particle size 0.5 mm are mixed in water, and are filtered, and thereby zirconia particles each carrying the graphene oxide are obtained. The particles are dispersed in water, and are filled in the adsorption tank shown in FIG. 1.

Wastewater containing phenol and copper ions is flowed in the adsorption tank, and thereby treated wastewater from which these have almost been removed can be obtained.

### Example 7

The graphene oxide to be obtained in the example 1 and alumina beads with a particle size 0.5 mm are mixed in water, and are filtered, and thereby alumina particles each carrying the graphene oxide are obtained. The particles are dispersed in water, and are filled in the adsorption tank shown in FIG. 1.

Wastewater containing uranium in a natural state is flowed in the adsorption tank, and thereby treated wastewater from which these have almost been removed can be obtained.

### Example 8

The graphene oxide to be obtained in the example 1 and alumina beads with a particle size 0.5 mm are mixed in water, and are filtered, and thereby alumina particles each carrying the graphene oxide are obtained. The particles are dispersed in water, and are filled in the adsorption tank shown in FIG. 1.

Wastewater containing dysprosium in a natural state is flowed in the adsorption tank, and thereby treated wastewater from which these have almost been removed can be obtained. Further, pH is adjusted to 2, and thereby dysprosium adsorbed by the adsorbent can be collected.

### Example 9

The graphene oxide to be obtained in the example 1 and zircon beads with a particle size 1 mm are mixed in water, and are filtered, and thereby zircon particles each carrying the graphene oxide are obtained. The particles are dispersed in water, and are filled in the adsorption tank shown in FIG. 1.

Wastewater containing dysprosium in a natural state is flowed in the adsorption tank, and thereby treated wastewater from which these have almost been removed can be obtained. Further, pH is adjusted to 2, and thereby dysprosium adsorbed by the adsorbent can be collected.

### Example 10

The graphene oxide obtained in the example 1 and triiron tetroxide particles with a particle size 500 nm are mixed in water, and are filtered, and thereby graphene oxide/triiron tetroxide particles are obtained. The particles are dispersed in water, and are filled in an adsorption tank of a batch type.

Wastewater containing phenol in a natural state is filled in the adsorption tank, and after the wastewater is stirred, a magnet is placed below the adsorption tank, to make the adsorbent to be precipitated. The supernatant liquid is in a state that phenol has almost been removed.

### Comparative Example 1

An adsorption test of phenol using graphite Z-5F in place of graphene oxide has been performed, but an adsorption rate of phenol is 0%.

### Comparative Example 2

In the same manner as the example 1 except that graphene oxide which has a shoulder peak at a wavelength of about 300 nm as shown in FIG. 3, and in which an absorbance at 600 nm is 13% of the absorbance at 300 nm, and a ratio of oxygen atoms to carbon atoms is 57% from the analysis by XPS is used, in place of the graphene oxide to be used in the example 1, an adsorption amount of phenol is measured. The adsorption amount of phenol is 12%.

### Comparative Example 3

In the same manner as the example 1 except that graphene oxide which has a shoulder peak at a wavelength of about 300 nm, and in which an absorbance at 600 nm is 65% of an absorbance at 300 nm, and a ratio of oxygen atoms to carbon atoms is 7% from the analysis by XPS is used, in place of the graphene oxide to be used in the example 1, an adsorption amount of phenol is measured. The adsorption amount of phenol is 20%.

### Comparative Example 4

In the same manner as the example 2 except that DIAION pK228 that is a strongly acidic cation exchange resin made of Mitsubishi Chemical is used, in place of graphene oxide, adsorption of dysprosium is checked. Masses mg of dysprosium per ion exchange resin of 1 g are 26 mg at pH 4, 13 mg at pH 5, 5 mg at pH 6, 5 mg at pH 7, and the absorbing power at a neutral region is small.

### DESCRIPTION OF SYMBOLS

10 . . . adsorption apparatus, 11 . . . adsorbent, 12 . . . adsorption tank, 12a . . . upper portion, 12b . . . lower portion, 13 . . . supply source of water containing substance to be adsorbed, 14, 16, 18, 20 . . . on-off valve, 15 . . . treated water discharge portion, 17 . . . adsorbent discharge portion, 19 . . . adsorbent supply source, 21 . . . pH adjusting agent supply source, 22, 23 . . . filter, L1, L4, L5 . . . supply line, L2, L3 . . . discharge line, P1, P4, P5 . . . supply pump, P2, P3 . . . discharge pump

What is claimed is:

1. An adsorbent comprising:
graphene oxide having a shoulder peak at a wavelength of about 300 nm,
wherein an absorbance at 600 nm is not less than 15% and not more than 60% of an absorbance at 300 nm.

2. The adsorbent according to claim 1, wherein:
nitrogen atoms are contained not less than 0.1% and not more than 30% of carbon atoms in the graphene oxide.

3. The adsorbent according to claim 1, wherein:
a ratio of oxygen atoms to carbon atoms in the graphene oxide is not less than 10% and not more than 50%.

4. The adsorbent according to claim 1, wherein:
the graphene oxide is carried on a carrier.

5. The adsorbent according to claim 4, wherein:
the carrier has a surface potential which is about 0 mV or positive in a neutral state.

6. The adsorbent according to claim 4, wherein:
the carrier is at least one selected from titania, alumina, zirconia, and zircon.

7. The adsorbent according to claim 4, wherein:
the carrier has magnetism.

8. An adsorption apparatus, comprising:
an adsorption tank having adsorbent containing graphene oxide;
means for supplying water containing substance to be adsorbed which can be adsorbed by the adsorbent; and
means for discharging water in which at least a part of the substance to be adsorbed has been adsorbed by the adsorbent;
wherein the adsorbent has a shoulder peak at a wavelength of about 300 nm of the graphene oxide, and an absorbance at 600 nm is not less than 15% and not more than 60% of an absorbance at 300 nm.

9. The adsorption apparatus according to claim 8, further comprising:
pH adjusting means for controlling pH in the adsorption tank.

10. The adsorption apparatus according to claim 8, wherein:
in the adsorbent, nitrogen atoms are contained not less than 0.1% and not more than 30% of carbon atoms in the graphene oxide.

11. The adsorption apparatus according to claim 8, wherein:
in the adsorbent, a ratio of oxygen atoms to carbon atoms in the graphene oxide is not less than 10% and not more than 50%.

12. The adsorption apparatus according to claim 8, wherein:
in the adsorbent, the graphene oxide is carried on a carrier.

13. The adsorption apparatus according to claim 12, wherein:
in the adsorbent, the carrier has a surface potential which is about 0 mV or positive in a neutral state.

14. The adsorption apparatus according to claim 12, wherein:
in the adsorbent, the carrier is at least one selected from titania, alumina, zirconia, and zircon.

15. The adsorption apparatus according to claim 12, wherein:
in the adsorbent, the carrier has magnetism.
